(19) United States
(12) Patent Application Publication
(10) Pub. No.: US 2010/0013721 A1
(43) Pub. Date: Jan. 21, 2010

(54) ANTENNA DEVICE AND PORTABLE RADIO APPARATUS USING THE SAME

(76) Inventor: Takuya Kojima, Saitama (JP)

Correspondence Address: Mr. Jackson Chen, 6535 N. STATE HWY 161, IRVING, TX, 75039, US

(21) Appl. No.: 12/518,682

(22) PCT Filed: Dec. 26, 2007
(86) PCT No.: PCT/JP2007/074963

§ 371 Date: Jun. 11, 2009

(30) Foreign Application Priority Data
Dec. 28, 2006 (JP) 2006-353615

(51) Int. Cl. H01Q 5/00; H01Q 1/24; H01Q 9/04

(52) U.S. Cl. 343/702; 343/700 MS

(57) ABSTRACT

Disclosed is antenna device (1) comprising antenna board (20) including HI-Board antenna element (3), HI-Band feeding point (4a) electrically connected to HI-Band antenna element (3), LOW-Band antenna element (2), and LOW-Band feeding point (4b) electrically connected to LOW-Band antenna element (2). HI-Band feeding point (4a) is arranged on the side of first lateral portion (20a) of antenna board (20), and LOW-Band feeding point (4b) is arranged on the side of second lateral portion (20b) opposite to the side of first lateral portion (20a).

### TECHNICAL FIELD

The present invention relates to an antenna device and a portable radio apparatus using the same.

### BACKGROUND ART

Nowadays, mobile phones are required to provide communications that of various frequency bands. Even in this situation, they are required to be smaller and slimmer so it is difficult to ensure space for mounting plural antennas therein. For this reason, what is required is a single antenna that can operate in multiple frequency bands.

As one example of an antenna operating in plural frequency bands, elements of two distant frequency bands may be combined to form two frequencies. FIG. 1 shows the construction of one example of a dual-frequency antenna related to the present invention, which operates in Band I (1920 MHz-2170 MHz) and Band VI (830 MHz-885 MHz) based on the WCDMA system. Antenna device 101 shown in FIG. 1 connects antenna element 103 for use with HI-Band and antenna element 102 for use with LOW-Band at feeding point 104 to realize a dual-frequency antenna. Also, FIG. 2 shows antenna impedance when an antenna based on techniques related to the present invention is mounted in the lower housing hinge section of a folding-type mobile phone. FIG. 2 is the Smith chart, the impedance locus of which ranges from 700 MHz to 2300 MHz, ◯ indicating LOW-Band (824 MHz-960 MHz), ⋄ indicating HI-Band (1710 MHz-2170 MHz). Therefore, by extracting two antenna elements from a single feeding point, a dual-frequency antenna can be constituted.

Japanese Patent Application Laid-Open No. 2005-244553 discloses a radio device which includes two independent feeding points and two independent matching circuits.

### DISCLOSURE OF THE INVENTION

### Technical Problem

When an antenna operating in both the WCDMA mode and the GSM mode is considered, it should be ensured that the antenna will operate in a band up to 824 MHz-960 MHz in LOW-band, and in a band up to 1710 MHz-2170 MHz in HI-Band.

In the meantime, in order to prevent loss due to reflection when a radio circuit and an antenna are combined, an impedance matching circuit which combines inductance or a capacitance is arranged between the radio circuit and the antenna to thereby achieve matching. That is, inductance or capacitance arranged in an impedance matching circuit is adjusted to achieve matching with a radio circuit.

FIG. 3 shows the Smith chart of an example of the impedance of an antenna after being matched using an impedance matching circuit, and this antenna is designed by techniques related to the present invention and is mounted in a lower housing hinge section of a folding-type mobile phone. The circle drawn at the center of the Smith chart with broken lines indicates a circle having a fixed VSWR (Voltage Standing Wave Ratio) and the portion inside the circle corresponds to a range where antenna matching is done. As shown in FIG. 3, since the corresponding band is broad, the LOW-Band and HI-Band are not all matched. That is, FIG. 3 shows that it is difficult to ensure antenna characteristics over a broadband because, in a single-feed dual-frequency antenna which is constructed in conformity with techniques related to the present invention, a LOW-Band antenna and a HI-Band antenna are connected, and mutual impedance between them is affected.

Also, since every frequency has a different variation range of impedance, it is hard to match the impedance of the Low-Band antenna and of the HI-Band antenna at an intended position. Thus, a switch function such as a PIN diode is used to change the impedance matching circuit for each band and to therefore achieve matching. In case of changing the matching circuit using a switch, the loss within the impedance matching circuit is increased due to the resistance component or the like, resulting in degradation of antenna characteristics.

In addition, even though two independent feeding points and two independent matching circuits are provided in the configuration disclosed in Japanese Patent Application Laid-Open No. 2005-244553, the feeding points and the matching circuits are arranged close to each other. For this reason, the construction disclosed in Japanese Patent Application Laid-Open No. 2005-244553 also makes it difficult to ensure antenna characteristics over a broadband because the impedance of each feeding point and of each matching circuit influence each other.

Therefore, the object of the present invention is directed to provide an antenna device capable of ensuring antenna characteristics over a broadband, and a portable radio apparatus using the same.

### Technical Solution

In order to accomplish the above objects, an antenna device of the present invention comprises an antenna board, including a first antenna element operating in a first frequency band, a first feeding point electrically connected to the first antenna element, a second antenna element operating in a second frequency band which is a lower frequency band than the first frequency band, and a second feeding point electrically connected to the second antenna element, the first feeding point being arranged on the side of a first lateral portion of the board, the second feeding point being arranged on the side of a second lateral portion opposite to the first lateral portion of the board.

As discussed above, in the antenna device of the present invention, the first feeding point and the second feeding point are arranged on the board at a distance from each other. For this reason, feeding points are restrained from influencing the mutual impedance each other, and therefore, predetermined antenna characteristics over a broadband can be ensured in the antenna device of the present invention. Moreover, since a feeding point is provided for each frequency band, impedance matching can also be adjusted easily, compared with a single-feed antenna by techniques related to the present invention.

In the antenna device of the present invention, the first antenna element and the second antenna element are arranged between the first feeding point and the second feeding point. This construction makes efficient use of the mounting region of the board, which in turn enables realizing an antenna device of smaller size.

Also, in the antenna device of the present invention, the first antenna element and the second antenna element are arranged in a manner in which an open side of the first antenna element and an open side of the second antenna element are disposed at a distance from each other in a direction where the first feeding point and the second feeding point are arranged.

A portable radio apparatus of the present invention comprises the antenna device according to the present invention.

Also, the portable radio apparatus of the present invention comprises a first matching circuit which is a matching circuit for the first antenna element, an a second matching circuit which is a matching circuit for the second antenna element, wherein the first matching circuit is arranged adjacent to the first feeding point of the board mounted in the portable radio apparatus, and the second matching circuit is arranged adjacent to the second feeding point of the board mounted in the portable radio apparatus. With this construction, it becomes possible to suppress not only the influence on mutual impedance between the feeding points, but also the influence on mutual impedance between the matching circuits.

Also, the portable radio apparatus of the present invention comprises a first housing including an image display and a first print circuit board, a second housing including a microphone and a second print circuit board, a connection board for electrically connecting the first print circuit board and the second print circuit board, a hinge for pivotably connecting the first housing and the second housing, and a first joint member and a second joint member for electrically connecting the first feeding point and the second feeding point of the antenna device to the second print circuit board, respectively, the connection board being arranged to pass in-between the first joint member and the second joint member. In this case, the space created in the first and second joint members can be utilized efficiently.

Also, in the portable radio apparatus of the present invention, the antenna device may be arranged on a side where the hinge is installed, the side being within the second housing, or, alternatively, the antenna device may be arranged on a side opposite to a side where the microphone is installed, the side being within the second housing.

Also, the portable radio apparatus of the present invention comprises a first housing including an image display and a first print circuit board, a second housing including a microphone and a second print circuit board, a connection board for electrically connecting the first print circuit board and the second print circuit board, a hinge for pivotably connecting the first housing and the second housing, and a first joint member and a second joint member for electrically connecting the first feeding point and the second feeding point of the antenna device to the second print circuit board, respectively, with the connection board being arranged to pass in-between the first joint member and the second joint member.

Also, in the portable radio apparatus of the present invention, the antenna device may be arranged on a side where the hinge is installed, the side being within the first housing.

### ADVANTAGEOUS EFFECTS

According to the present invention, the first feeding point and the second feeding point are arranged on the board at a distance from each other, so they do not influence the mutual impedance of each other, while ensuring predetermined characteristics over a broadband.

### DESCRIPTION OF DRAWINGS

FIG. 1 is a schematic view showing an example of the construction of an antenna device by techniques related to the present invention;

FIG. 2 is a Smith chart showing an example of the impedance of an antenna device by techniques related to the present invention;

FIG. 3 is a Smith chart after impedance matching is achieved in an antenna device by techniques related to the present invention;

FIG. 4 is a schematic view showing an example of the construction of an antenna device according to the present invention;

FIG. 5 is a side sectional view of an example of a folding-type mobile phone having an antenna device according to the present invention mounted thereon;

FIG. 6A is a schematic view showing the construction of the periphery of an antenna device according to the present invention, more particularly, a plan view including the periphery of an antenna device;

FIG. 6B is a schematic view showing the construction of the periphery of an antenna device according to the present invention, more particularly, a sectional view of an antenna device;

FIG. 7A is an example of a Smith chart showing the impedance of an antenna device according to the present invention, particularly a LOW-Band antenna;

FIG. 7B is an example of a Smith chart showing the impedance of an antenna device of the present invention, particularly a HIGH-Band antenna;

FIG. 8A is an example of a Smith chart after impedance matching is done in an antenna device according to the present invention, particularly a LOW-Band antenna;

FIG. 8B is an example of a Smith chart after impedance matching is done in an antenna device of the present invention, particularly a HIGH-Band antenna;

FIG. 9 is a side sectional view of another example of a folding-type mobile phone having an antenna device according to the present invention mounted thereon; and

FIG. 10 is a side sectional view of yet another example of a folding-type mobile phone having an antenna device according to the present invention mounted thereon.

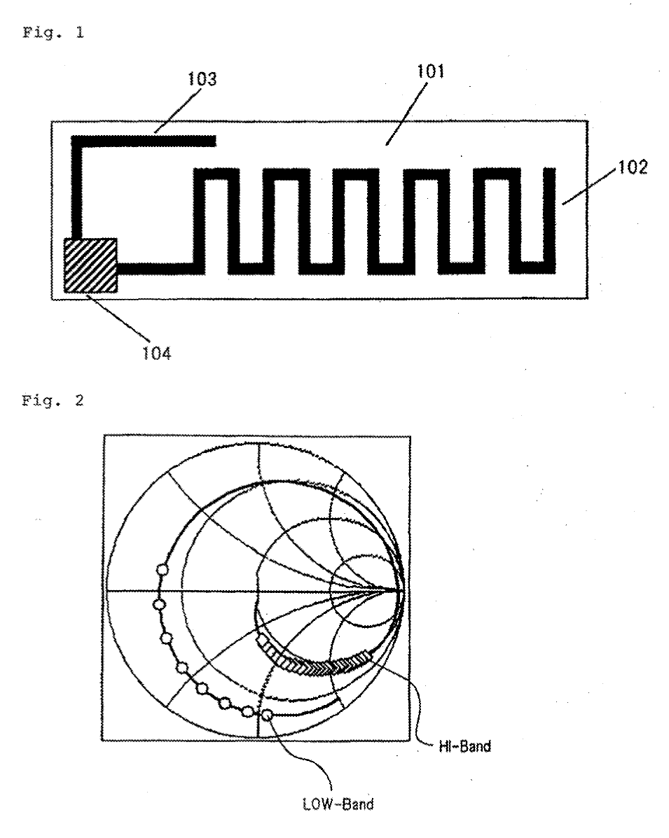

### MODE FOR INVENTION

An exemplary embodiment of the present invention is explained hereinafter with reference to the accompanying drawings.

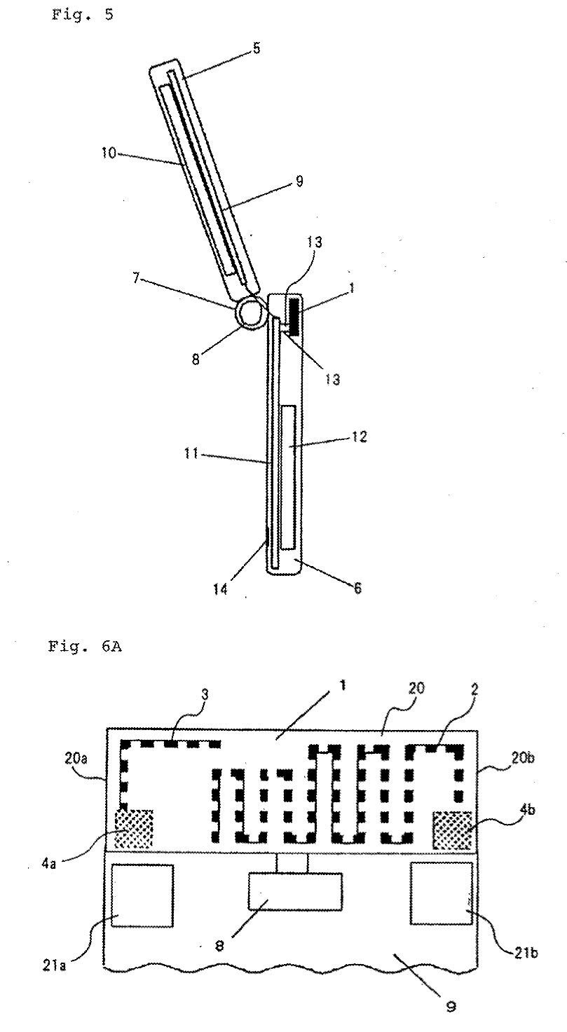

FIG. 4 is a schematic view showing an example of the construction of an antenna device according to the present invention.

Antenna device 1 includes LOW-Band antenna element 2 and HI-Band antenna element 3 which are independently arranged within one antenna board 20. Also, antenna device 1 is provided with HI-Band feeding point 4a and LOW-Band feeding point 4b which respectively supply power to LOW-Band antenna element 2 and HI-Band antenna element 3 and which are arranged independently of each other with a distance therebetween. In order for an antenna to operate in both the WCDMA mode and the GSM mode, it must be made certain that LOW-Band antenna element 2 will operate in 824 MHz-960 MHz, and HI-Band antenna element 3 will operate in 1710 MHz-2170 MHz.

HI-Band feeding point 4a is provided on the side of first lateral portion 20a of antenna board 20, which is also close to corner 21a. In FIG. 4, HI-Band feeding point 4a is arranged at the lower left of antenna board 20, while LOW-Band feeding point 4b is provided on the side of second lateral portion 20b of antenna board 20, which is also close to corner 21b. In FIG. 4, LOW-Band feeding point 4b is arranged at the lower right of antenna board 20. Such arrangement provides a certain distance between HI-Band feeding point 4a and LOW-Band feeding point 4b where a lot of current flows within antenna board 20, so that the impedance of HI-Band feeding point 4a and LOW-Band feeding point 4b will not influence each other. Furthermore, HI-Band feeding point 4a and LOW-Band feeding point 4b may be arranged diagonally on antenna board 20 in order to increase the distance between the two. For example, HI-Band feeding point 4a may be placed on corner 21a, and LOW-Band feeding point 4b may be placed on corner 21c. Alternatively, HI-Band feeding point 4a may be placed on corner 21d, and LOW-Band feeding point 4b may be placed on corner 21b.

Accordingly, for antenna device 1 according to this embodiment, HI-Band feeding point 4a and LOW-Band feeding point 4b are arranged on both lateral portions 20a and 20b of antenna board 20, and HI-Band antenna element 3 and LOW-Band antenna element 2 are arranged between both feeding points 4a and 4b. More specifically, HI-Band antenna element 3 and LOW-Band antenna element 2 are arranged, extending towards the inside of antenna board 20 from each of feeding points 4a and 4b. That is, HI-Band antenna element 3 has a layout such that base portion 3b thereof is electrically connected to side 4a1 of HI-Band feeding point 4a and extends towards corner 21d, and such that open side 3a thereof is directed towards the inside of antenna board 20 from corner 21d. Also, LOW-Band antenna element 2 has a layout such that base portion 2b thereof is electrically connected to side 4b1 of LOW-Band feeding point 4b and extends towards corner 21c, forming a rectangular wave shape from corner 21c, and such that open side 2a thereof is directed towards the inside of antenna board 20.

As explained above, a board mounting region for antenna board 20 may be utilized in an efficient manner by arranging antenna elements 2 and 3 between both feeding points 4a and 4b, which in turn enables making antenna board 20 smaller.

Referring again to FIG. 4, although HI-Band feeding point 4a and HI-Band antenna element 3 are arranged on the left side of antenna board 20 and LOW-Band feeding point 4b and LOW-Band antenna element 2 are arranged on the right side of antenna board 20, it could also be done the other way around.

The aim of the present invention is to arrange feeding points 4a and 4b where a lot of current flows as far as possible from each other such that the impedance of feeding points 4a and 4b do not influence each other. In FIG. 4, for example, open side 3a of HI-Band antenna element 3 and open side 2a of LOW-Band antenna element 2 are placed at locations where they slightly overlap in the horizontal direction. This shows an example of a layout where antenna board 20 can be as small as possible and feeding points 4a and 4b can be separated as far as possible from each other. Therefore, if use of antenna board 20, whose size is large, is allowed, open sides 2a and 3a will not overlap at all in the horizontal direction. In other words, HI-Band antenna element 3 and LOW-Band antenna element 2 may be designed in a manner in which open sides 3a and 2a thereof are arranged to have a gap or distance between each other in the direction (x direction in FIG. 4) where HI-Band feeding point 4a and LOW-Band feeding point 4b are arranged.

Moreover, although FIG. 4 shows an example where HI-Band antenna element 3 extending from side 4a1 of HI-Band feeding point 4a and LOW-Band antenna element 2 extending from side 4b1 of LOW-Band feeding point 4b are arranged between feeding points 4a and 4b, the present invention is not limited thereto. For example, HI-Band antenna element 3 may be extended from side 4a2 of HI-Band feeding point 4a, and LOW-Band antenna element 2 may be extended from side 4b2 of LOW-Band feeding point 4b. That is, any construction that separates feeding points 4a and 4b as far as possible from each other and that makes efficient use of the space between them may be adopted.

Next, FIG. 5 shows a side sectional view of a folding-type mobile phone having antenna device 1 according to this embodiment.

The folding-type mobile phone shown in FIG. 5 includes upper housing 5 and lower housing 6 pivotably connected together by hinge 7. Upper housing 5 accommodates upper print circuit board 9, display 10, etc. Lower housing 6 accommodates, in its interior, antenna device 1, lower print circuit board 11, cell 12, microphone 14, etc. Upper print circuit board 9 and lower print circuit board 11 are electrically connected by upper-lower board connecting portion 8 which consists of flexible substrates. Antenna device 1 is arranged inside lower housing 6 close to hinge 7.

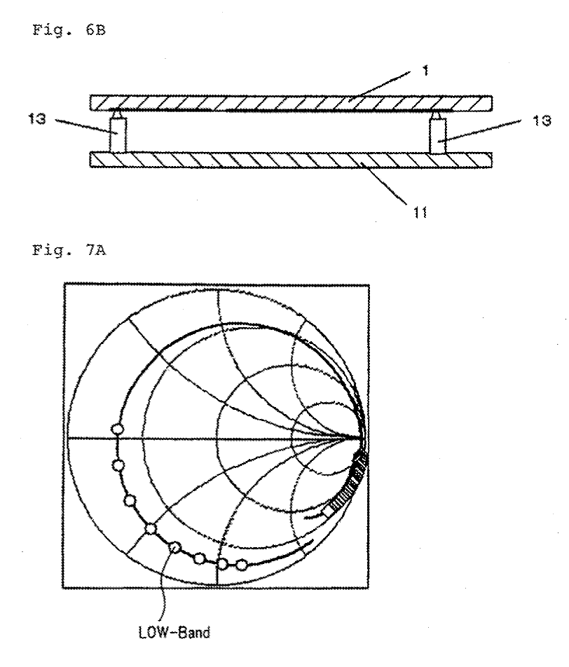

FIGS. 6A and 6B show the construction of the periphery of an antenna device. FIG. 6A is a plan view including the periphery of antenna device 1, and FIG. 6B is a sectional view of antenna device 1.

As shown in FIG. 6A, antenna matching circuit 21a is connected to HI-Band feeding point 4a, and antenna matching circuit 21b is connected to LOW-Band feeding point 4b. Also, these antenna matching circuits 21a and 21b are electrically connected to lower print circuit board 11. Each of antenna matching circuits 21a and 21b is an impedance matching circuit which combines inductance or a capacitance to prevent the loss due to reflection when a radio circuit and an antenna are combined. Antenna matching circuits 21a and 21b each cause the antenna and radio circuit to have impedance matching with each other, by adjusting the inductance or capacitance provided inside thereof.

However, if antenna matching circuits 21a and 21b that have such a function are arranged too close to each other, the impedance of feeding points 21a and 21b influence each other. Therefore, to separate the matching circuits from each other, once antenna board 20 is mounted in a folding-type mobile phone, antenna matching circuit 21a is installed adjacent to HI-Band feeding point 4a, while antenna matching circuit 21b is installed adjacent to LOW-Band feeding point 4b.

Also, as shown in FIG. 6B, each of feeding points 4a and 4b is electrically connected to lower print circuit board 11 by antenna feed terminal 13. In case of antenna device 1 according to this embodiment, because feeding points 4a and 4b, antenna matching circuits 21a and 21b and antenna feed terminals 13 are placed on both sides of antenna board 20, there are spaces between each pair. Accordingly, this embodiment aims to make efficient use of the spaces by allowing upper-lower board connecting portion 8 to pass therethrough. Also, this efficient use of the space enables reduction of the size of folding-type mobile phones.

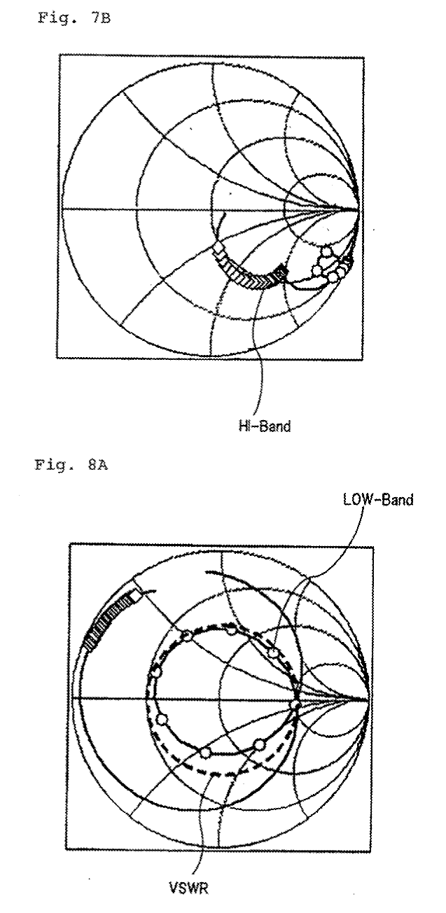

FIGS. 7A and 7B are Smith charts, each showing the antenna impedance of a folding-type mobile phone according to this embodiment. The impedance locus in each figure is a calculated value from 700 MHz to 2300 MHz, ◯ indicating a range of LOW-Band (824 MHz-960 MHz), ⋄ indicating a range of HI-Band (1710 MHz-2170 MHz). FIG. 7A shows the impedance in the LOW-Band range, and FIG. 7B shows the impedance in the HIGH-Band range.

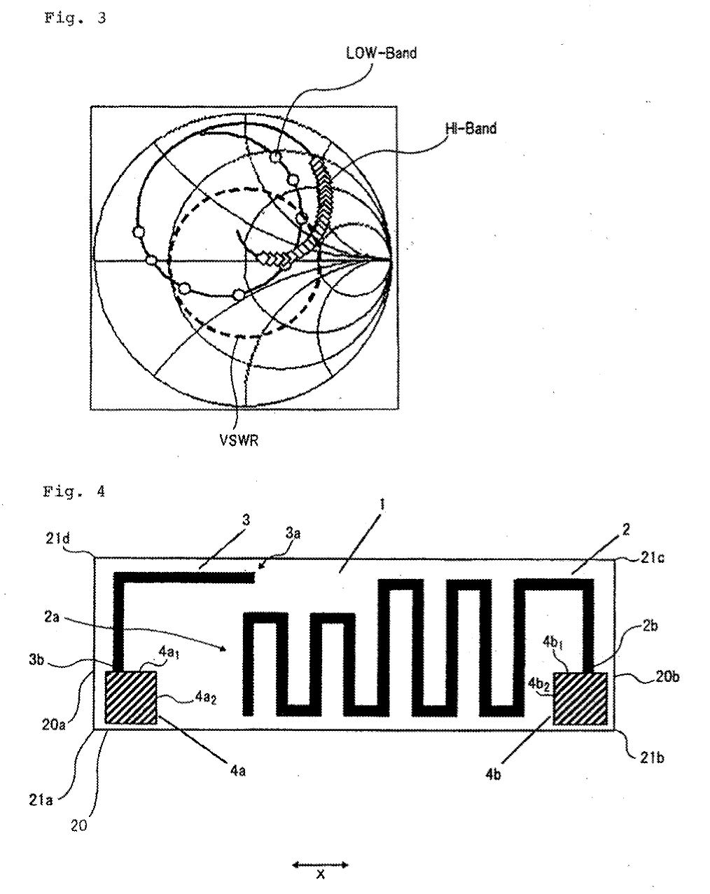

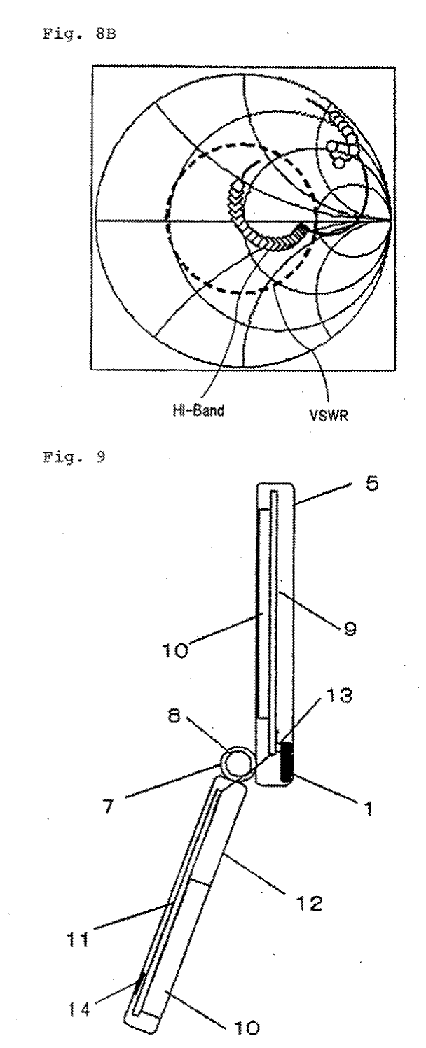

FIGS. 8A and 8B are Smith charts, each showing antenna impedance after matching for impedances is done using antenna matching circuit 21a, 21b. The circle drawn at the center of each of the Smith charts with broken lines indicates a circle having a fixed VSWR (Voltage Standing Wave Ratio) and the portion inside the circle corresponds to a range where impedance matching between the antenna and the circuit is done. FIG. 8A shows the impedance after matching in a LOW-Band range, and FIG. 8B shows the impedance after matching in a HIGH-Band range. Compared with FIG. 3, the portions indicated by ◯ and ⋄ are enclosed within the circle having a fixed VSWR, meaning that antenna device 1 according to this embodiment has matched impedances over a broadband in both LOW-Band and HI-Band ranges. This is the result or advantage of the separated layout of antenna matching circuits 21a and 21b in which impedances in the LOW-Band and HI-Band ranges are respectively and independently matched.

As explained so far, according to this embodiment, LOW-Band antenna element 2 and HI-Band antenna element 3 are arranged on both sides within one antenna board 20, and two feeding points, i.e. HI-Band feeding point 4a and LOW-Band feeding point 4b, are provided at a distance from each other. As a result, the mounting region of antenna board 20 is utilized very efficiently, and feeding points are restrained from influencing the mutual impedance each other. Thus, operation of the predetermined characteristics over a broadband is ensured in an antenna device that has configuration according to this embodiment. Moreover, in this embodiment, because impedance matching at independent feeding points 4a and 4b is done by antenna matching circuits 21a and 21b, respectively, impedance matching can also be adjusted easily, compared with a single-feed antenna by techniques related to the present invention.

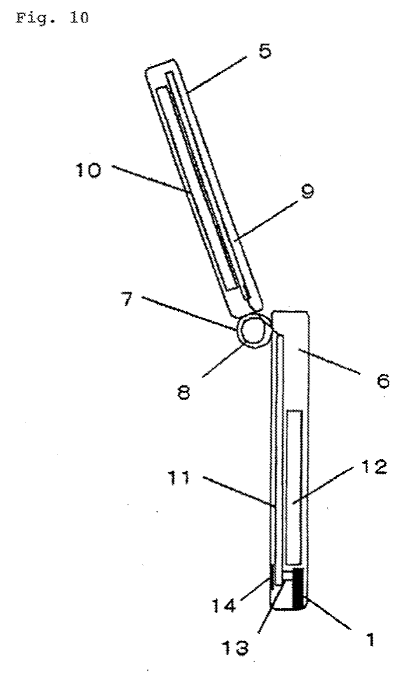

In a folding-type mobile phone, as shown in FIG. 9, antenna device 1 may be installed inside upper housing 5 and close to hinge 7, or, alternatively, as shown in FIG. 10, antenna device 1 may be installed inside lower housing 6 and close to microphone 14 provided on the opposite side of hinge 7. In the former case, antenna matching circuit 21a and antenna matching circuit 21b are connected to upper print circuit board 9.

This application claims a priority based on Japanese Patent Application No. 2006-353615 filed on Dec. 28, 2006, the entire contents of which are incorporated herein by reference.

1. An antenna device comprising:
an antenna board, including
a first antenna element operating in a first frequency band,
a first feeding point electrically connected to the first antenna element,
a second antenna element operating in a second frequency band that is lower than the first frequency band, and
a second feeding point electrically connected to the second antenna element,
wherein, the first feeding point is arranged on the side of a first lateral portion of the board, and the second feeding point is arranged on the side of a second lateral portion opposite to the first lateral portion.

2. The antenna device according to claim 1, wherein the first antenna element and the second antenna element are arranged between the first feeding point and the second feeding point.

3. The antenna device according to claim 2, wherein the first antenna element and the second antenna element are arranged in a manner in which an open side of the first antenna element and an open side of the second antenna element are disposed at a distance from each other in a direction where the first feeding point and the second feeding point are arranged.

4. A portable radio apparatus comprising the antenna device described in claim 1.

5. The portable radio apparatus according to claim 4, comprising:
a first matching circuit which is a matching circuit for the first antenna element; and
a second matching circuit which is a matching circuit for the second antenna element,
wherein the first matching circuit is arranged adjacent to the first feeding point of the board mounted in the portable radio apparatus, and the second matching circuit is arranged adjacent to the second feeding point of the board mounted in the portable radio apparatus.

6. The portable radio apparatus of claim 4, comprising:
a first housing including an image display and a first print circuit board;
a second housing including a microphone and a second print circuit board;
a connection board that electrically connects the first print circuit board and the second print circuit board;
a hinge that pivotably connects the first housing and the second housing; and
a first joint member and a second joint member that electrically connects the first feeding point and the second feeding point of the antenna device to the second print circuit board, respectively, with the connection board being arranged to pass in-between the first joint member and the second joint member.

7. The portable radio apparatus according to claim 6, wherein the antenna device is arranged on a side where the hinge is installed, the side being within the second housing.

8. The portable radio apparatus according to claim 6, wherein the antenna device is arranged on a side opposite to a side where the microphone is installed, the side being within the second housing.

9. The portable radio apparatus according to claim 4, comprising:
a first housing including an image display and a first print circuit board;
a second housing including a microphone and a second print circuit board;
a connection board that electrically connects the first print circuit board and the second print circuit board;
a hinge that pivotably connects the first housing and the second housing; and
a first joint member and a second joint member that electrically connects the first feeding point and the second feeding point of the antenna device to the second print circuit board, respectively, with the connection board being arranged to pass in-between the first joint member and the second joint member.

10. The portable radio apparatus according to claim 9, wherein the antenna device is arranged on a side where the hinge is installed, the side being within the first housing.
